(19) United States
(12) Patent Application Publication
(10) Pub. No.: US 2006/0068675 A1
(43) Pub. Date: Mar. 30, 2006

(54) Wet-lay flame barrier

(76) Inventors: Alan C. Handermann, Asheville, NC (US); David E. Weller JR., Newark, OH (US); Frank J. Land, Freeport, NY (US); John P. Blanchard, Oakland Township, MI (US)

Correspondence Address: WOMBLE CARLYLE SANDRIDGE & RICE, PLLC, P.O. BOX 7037, ATLANTA, GA, 30357-0037, US

(21) Appl. No.: 11/216,720

(22) Filed: Aug. 31, 2005

Related U.S. Application Data
(60) Provisional application No. 60/606,383, filed on Sep. 1, 2004.

(51) Int. Cl. D04H 1/00; B32B 5/24; D04H 13/00; B32B 5/18

(52) U.S. Cl. 442/415; 442/414; 428/920; 428/921; 428/219; 442/370

(57) ABSTRACT

Nonwoven wet-lay flame barrier of the invention comprises a blend of water dispersible fibers, that are inherently fire resistant and nonshrinking to direct flame, along with water dispersible fibers extruded from polymers made with halogenated monomers and optionally including fiberglass and wood pulp, being together thermally bonded with a binder resin in a wet-lay manufacturing process to provide a relatively thin, but dense, durable flame barrier with excellent tensile, and durability properties in the end use application. The wet-lay flame barrier of this invention also allows for the manufacture of open flame resistant composite articles, while also permitting the continued use of conventional non-flame retardant dress cover fabrics, conventional non-flame retardant fiberfills and conventional non-flame retardant polyurethane foams.

### RELATED APPLICATIONS

This application is a non-provisional application claiming the benefit of Provisional Application Ser. No. 60/606,383, filed Sep. 1, 2004, the content of which is hereby incorporated in its entirety.

### BACKGROUND OF THE INVENTION

1. Field of the Invention

The invention relates to a flame barrier, made in a wet-lay process, that is well suited for use in mattress and foundation, upholstered furniture, transportation seating and building insulation applications or any other end use where a relatively thin, relatively dense material is desired for flame barrier purposes. A preferred wet-lay produced flame barrier of the invention comprises a water dispersible combination of fibers, which include water dispersible organic fibers that are inherently flame resistant and nonshrinking to direct flame and other water dispersible organic fibers that are spun from polymers that include halogenated monomers, along with a flame resistant binder resin. The wet-lay flame barrier may also include water dispersible inorganic fibers, such as glass fibers and/or water dispersible pulp fibers. Polymeric fibers that are made with halogenated monomers generate oxygen-depleting gases when exposed to flames and flame temperatures. These oxygen depleting gases help to prevent auto ignition of the decomposition products coming from the underlying layers of, for example, polyurethane foam and they also help extinguish residual flame which may emanate from overlying dress cover fabric or the like. The oxygen depleting gases which are generated from fibers which are spun from polymers that are made with halogenated monomers also coat and protect the carbonaceous char formed during the decomposition of the other inherently flame resistant fibers and carbonaceous materials, thereby providing a significantly longer time before the char disintegrates when exposed to air at open flame temperatures. These synergistic blends are then able to withstand extended periods of time with virtually no shrinkage of the char barrier; thereby preventing flame from “breaking through” and igniting the underlying materials. Other water dispersible non-flame resistant component fibers can also, optionally, be included in the blend, preferably at relatively low concentrations, such as: natural fibers and/or synthetic fibers, to improve product economics in the end use application. The wet-lay produced flame barrier of this invention also allows for the manufacture of open flame resistant composite articles, while also permitting the continued use of conventional non-flame retardant dress cover fabrics, conventional non-flame retardant fiberfills and conventional non-flame retardant polyurethane foams and the like.

2. Description of the Related Art

It is well known in the textile industry to produce fire resistant products for use in upholstered furniture, mattresses, foundations, automotive seating, public transportation seating, aircraft seating and the like, using needlepunched, highloft, spunbond or spunlace nonwoven or woven or knit fabrics formed of natural or synthetic fibers, and then treating these fabrics with fire retarding chemicals. Conventional fire retarding (FR) chemicals include borate-based, halogen-based, phosphorus-based, melamine-based and/or antimony-based chemicals. Unfortunately, such treated fabrics are heavier than similar types of non-fire retardant fabrics, and have reduced wear life. Although FR chemically treated fabrics will self-extinguish and exhibit limited melt behavior when a flame is removed, they typically form brittle chars, shrink and crack open after exposure to a direct flame allowing the underlying materials to ignite. When fabrics made with FR treated cotton, FR polyester and other FR treated fabrics are used in composite articles such as upholstered furniture and mattresses and foundations, these composite article are usually deemed unsuited for passing the more stringent open flame tests such as: California Test Bulletin 133 (TB133), California Test Bulletin 129 “Flammability Test Procedure for Mattresses for use in Public Buildings”, October 1992 (TB129), California Test Bulletin 603 (TB603), and British Standard 5852-Crib 5 (BS5852) without the use of an additional flame barrier or FR backcoating materials.

Some of the flame barrier fabrics currently being used with the goal to pass the more stringent open flame tests, such as TB129, TB133 and TB603 include:
1) A woven polymer coated 100% fiberglass flame barrier (Sandel® Fabric, Sandel International Inc.)
2) A woven or knit core-spun yarn based flame barrier, where natural and/or synthetic fibers are wrapped around a multifilament fiberglass core and then optionally treated with FR chemicals and/or a coating of thermoplastic polyvinyl halide composition, such as polyvinyl chloride (Firegard® Seating Barriers, Intek; Firegard® Brand Products, Chiquola Fabrics, LLC)
3) A nonwoven hydroentangled spunlace flame barrier made of 100% p-aramid (Thermablock™ Kevlar® Z-11, DuPont Company)
4) A woven or knit core-spun yarn based flame barrier where natural and/or synthetic fibers are wrapped around a multifilament glass and/or a spun p-aramid core yarn and then optionally treated with FR chemicals and/or a coating of thermoplastic polyvinyl halide composition, such as polyvinyl chloride (Firegard® Seating Barriers, Intek; Firegard® Brand Products, Chiquola Fabrics, LLC, Alessandra FR barrier cloth, McKinnon-Land, LLC)
5) A nonwoven flame resistant highloft barrier (relatively thick, low density batting) made from blends of inherently FR or FR chemically treated fibers and fibers containing halogenated monomers (Protech™ FR Highloft, Carpenter Co.)

The disadvantages of the above mentioned flame barrier solutions for more stringent open-flame applications in upholstered furniture and other fiber-filled applications include:
a) Woven flame barriers, especially when coated with FR materials, impart a stiff “hand” to the composite article, which negatively affect the feel of the final product.
b) Many woven, nonwoven and knit flame barriers must be either laminated to the decorative fabric or double upholstered during manufacturing. This increases the number and complication of the dress cover fabrics, thereby increasing manufacturing costs.
c) 100% fiberglass flame barriers have poor durability due to glass-to-glass abrasion.
d) Woven and knit flame barriers made with natural fiber wrapped core-spun yarns must be made in heavy weight constructions (i.e. ˜10 opsy or 336 g/m²) to be effective flame barriers, and can negatively affect the feel of the composite article.
e) Natural fiber wrapped core-spun yarn fabrics require additional FR chemical treatments and/or coatings of a thermoplastic polyvinyl halide composition, such as polyvinyl chloride to be effective in passing the more stringent open-flame tests. This negatively impacts the workplace by having to handle these chemicals and increases the exposure of chemicals to the consumer who uses the composite article.
f) Hydroentangled nonwoven spunlace flame barriers, containing significant amounts of p-aramid fibers, which impart a yellow color to the flame barrier and negatively effect the look of the composite article, especially when used directly under white or light-colored decorative upholstery and/or mattress ticking fabrics and are negatively affected by UV light.
g) Woven and knit flame barriers add a significant cost to the composite article because they require a yarn formation step, which is eliminated in the formation of a nonwoven wet-lay flame barrier of the invention.
h) Flame resistant highloft barrier fabric, although well suited for some applications where fill power and bulk are desired characteristics, are a detriment in barrier applications where thin barrier materials are desired for increased manufacturing speed and/or aesthetic appeal.

### SUMMARY OF THE INVENTION

To overcome or conspicuously ameliorate the disadvantages of the related art, it is an object of the present invention to provide a wet-lay flame barrier able to pass stringent open flame tests. In its preferred usage in the present application, the term “flame barrier” means a product incorporated into a composite article that when tested with a composite type test method, such as: California Test Bulletin 129 (TB129) or California Test Bulletin 603 (TB603) for mattresses and foundations and California Test Bulletin 133 (TB133) for upholstered furniture, the flame barrier allows for the continued use of conventional materials such as dress cover fabrics, fiber-fillings and polyurethane foams, while still passing these stringent large open flame tests. It is understood by someone skilled in the art that flame barriers made of the fiber combinations described in this invention, even at overall lower basis weights, can be made to pass less stringent open flame tests such California's Revised Test Bulletin 117 (TB117—draft 02/02 version) and California's Test Bulletin 604 (TB604—draft test method available through California Bureau of Home Furnishings and Thermal Insulation by contacting contactbhfti@dca.ca.gov) or other small open flame tests.

In its preferred usage in the present application, the term “wet-lay” is in reference to (i) relatively thin and dense nonwoven fiber structure, preferably having a greater volume of fiber than air. The wet-lay nonwoven material of the present invention preferably has a basis weight of 30 to 300 g/m², more preferably 45 to 150 g/m² and even more preferably, for many intended uses, 60 to 100 g/m². The wet-lay nonwoven material of the present invention also preferably has a thickness falling within a range of 0.1 to 2 mm, more preferably 0.2 to 1 mm and even more preferably 0.3 to 0.75 mm being deemed well suited for many uses of the present invention. As having too low a basis weight for a given thickness at the higher end of the above basis weight ranges could degrade the barrier effect in some instances, it is desirable for some applications to use the lower end basis weight values in conjunction with lower end thickness ranges while the higher end basis weight are generally not subject to the same concerns. Accordingly, a basis weight 30 g/m² with a thickness range of 0.1 to 0.2 mm, or 60 g/m² with a thickness range of 0.2 to 0.4 mm, or 120 g/m² with a thickness range of 0.4-0.8 mm or 180 g/m² with a thickness range of 0.6-1.2 mm, represent preferred basis weight/thickness combinations under the present invention. The foregoing thickness ranges show preferred ranges relative to the noted basis weights that are well suited for typical intended usages of the present invention, but thickness levels above and below the noted ranges are also possible relative to the noted basis weights and vice versa depending of the desired flame barrier requirements and intended usage.

In accordance with the present invention a wet-lay density level of 50 kg/m³ to 500 kg/m³ or, more preferably 75 kg/m³ to 400 kg/m³, and even more preferably, 100 kg/m³ to 300 kg/m³ is well suited for the flame barrier purposes of the present invention.

The preferred denier values of the fibers used in the nonwoven wet-lay fiber blend of the present invention preferably are in the range of 0.8 to 200 dtex, with ranges of 0.9 to 50 dtex and 1 to 28 dtex being well suited for many applications of the present invention.

The preferred staple lengths of the fibers used in the nonwoven wet-lay fiber blend of the present invention preferably are in the range of 3 to 51 mm, with ranges of 6 to 38 and 12 to 32 being well suited form many applications of the present invention.

It is a further object of the invention to provide a composite article such a mattress and foundation or an upholstered furniture product manufactured with a nonwoven wet-lay flame barrier that passes more stringent open flame tests, such as TB133, TB603 and TB129.

Upon direct exposure to flame and high heat, the nonwoven wet-lay flame barrier of this invention forms a thin char with essentially no shrinkage in the x-y plane. This char forming behavior prevents cracking of the flame barrier, protecting the underlying layers of, for example, fiber-fill batting and/or foam materials in the composite article from being exposed to direct flame and high heat. The thin char also helps block the flow of oxygen and volatile decomposition gases. The char forming behavior of the preferred fiber blend in the nonwoven wet-lay flame barrier considerably lengthens the time it takes the underlying materials to decompose and ignite, by generating oxygen depleting gases which do not allow the volatile decomposition vapors of, for example, polyurethane to autoignite, and also help existing “surface” flame to self-extinguish.

In accordance with the invention, a nonwoven wet-lay flame barrier, for use in, for example, mattress, foundation, upholstered furniture, fiber-filled bed clothing, transportation seating and building insulation applications is produced by making an intimate water dispersible staple fiber blend from Category 1 and 2 fibers described hereinafter. Fibers or pulps from either or all of Categories 3, 4 and 5 may optionally be added. A binder resin, preferably flame resistant, is also required in the present invention, in order to bond all the fibers together into a strong, durable wet-lay flame barrier.

Category 1 fibers: Water dispersible versions of inherently flame-retardant, fibers such as; melamines, meta-aramids, para-aramids, polybenzimidazole, polyimides, polyamideimides, partially oxidized polyacrylonitriles, novoloids, poly (p-phenylene benzobisoxazoles), poly (p-phenylene benzothiazoles), polyphenylene sulfides, flame retardant viscose rayons; (e.g., viscose rayon based fiber containing 30% aluminosilicate modified silica, SᵢO₂+Al₂O₃ or chemically modified viscose rayon fiber containing phosphates) polyetheretherketones, polyketones, polyetherimides, and combinations thereof.

The above noted melamine is an example of a fiber that is inherently flame-retardant and shows essentially no shrinkage in the X-Y plane upon being subjected to open flame. Melamine fibers, for example, are sold under the tradename BASOFIL (available from McKinnon Land Moran, LLC). Melamine resin fibers used in conjunction with this invention can be produced for example by the methods described in U.S. Pat. Nos. 4,088,620, 5,084,488, and published European Applications EP093965 and EP221330, which are incorporated herein by reference. Particularly preferred melamine resin fibers include as monomer building block (A) from 90 to 100 mol % of a mixture consisting essentially from 30 to 100, preferably from 50 to 99, particularly preferably from 85 to 95, particularly from 88 to 93 mol % of melamine and from 0 to 70, preferably from 1 to 50, particularly preferably from 5 to 15, particularly from 7 to 12 mol % of a substituted melamine I or mixtures of substituted melamine I.

As further monomer building block (B), the particularly preferred melamine resin fibers include from 0 to 10, preferably from 0.1 to 9.5, particularly from 1 to 5 mol %, based on the total number of moles of monomer building blocks (A) and (B), of a phenol or a mixture of phenols.

The particularly preferred melamine resin fibers are customarily obtainable by reacting components (A) and (B) with formaldehyde or formaldehyde-supplying compounds in a molar ratio of melamines to formaldehyde within the range from 1:1.15 to 1:4.5, preferably from 1:1.8 to 1:3.0, and subsequent spinning.

Suitable substituted melamine of the general formula I 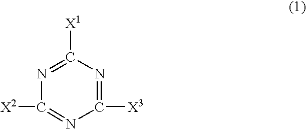
are those in which x¹, x², and x³ are each selected from the group consisting of —NH₂, —NHR¹, and —NR¹R², although x¹, x², and X³ must not all be —NH₂, and R¹ and R² are each selected from the group consisting of hydroxy-C₂-C₁₀-alkyl, hydroxy-C₂-C₄-alkyl-(oxa-C₂-C₄-alkyl)ₙ, where n is from 1 to 5, and amino-C₂-C₁₂-alkyl.

Hydroxy-C₂-C₁₀-alkyl is preferably hydroxy-C₂-C₆-alkyl such as 2-hydroxyethyl, 3-hydroxy-n-propyl, 2-hydroxyisopropyl, 4-hydroxy-n-butyl, 5-hydroxy-n-pentyl, 6-hydroxy-n-hexyl, 3-hydroxy-2,2-dimethylpropyl, preferably hydroxy-C₂-C₄-alkyl such as 2-hydroxyethyl, 3-hydroxy-n-propyl, 2-hydroxyisopropyl and 4-hydroxy-n-butyl, particularly preferably 2-hydroxyethyl or 2-hydroxyisopropyl.

Hydroxy-C₂-C₄-alkyl-(oxa-C₂-C₄-alkyl)ₙ preferably has n from 1 to 4, particularly preferably in n=1 or 2, such as 5-hydroxy-3-oxapentyl, 5-hydroxy-3-oxa-2,5-dimethylpentyl, 5-hydroxy-3-oxa-1,4-dimethylpentyl, 5-hydroxy-3-oxa-1, 2, 3, 4, 5-tetramethylpentyl, 8-hydroxy-3,6-dioxaoctyl.

Amino-C₂-C₁₂-alkyl is preferably amino-C₂-C₈-alkyl such as 2-aminoethyl, 3-aminopropyl, 4-aminobutyl, 5-aminopentyl, 6-aminohexyl, 7-aminoheptyl, and also 8-aminooctyl, particularly preferably 2-aminoethyl and 6-aminohexyl, very particularly preferably 6-aminohexyl.

Substituted melamine particularly suitable for the invention include the following compounds:
2-hydroxyethylamino-substituted melamines such as
2-(2-hydroxyethylamino)-4,6-diamino-1,3,5-triazine,
2,4-di-(2-hydroxyethylamino)-6-amino-1,3,5-triazine,
2,4,6-tris (2-hydroxyethylamino)-1,3,5-triazine,
2-hydroxyisopropylamino-substituted melamines such as
2-(2-hydroxyisopropylamino)-4,6-diamino-1,3,5-trizaine,
2,4-di-(2-hydroxsyisopropylamino)-6-amino-1,3,5-triazine,
2,4,6-tris (2-hydroxyisopropylamino)-1,3,5-triazine,
5-hydroxy-3-oxapentylamino-substituted melamines such as
2-(5-hydroxy-3-oxapentylamino)-4,6-diamino-1,3,5-triazine,
2,4,6-tris-(5-hydroxy-3-oxapentylamino)-1,3,5-triazine,
2,4-di(5-hydroxy-3-oxapentylamino)-6-amino; 1,3,5-triazine and
also 6-aminohexylamino substituted melamines such as
2-(6-aminohexylamino)-4,6-diamino-1,3,5-triazine
2,4-di(6-amino-hexylamino)-6 amino-1,3,5-triazine
2,4,6-tris (6-aminohexylamino)-1,3,5-triazine or mixtures of these compounds, for example a mixture of 10 mol % of
2-(5-hydroxy-3-oxapentylamino)-4,6-diamino-1,3,5-triazine,
50 mol % or 2,4-di (5-hydroxy-3-oxapentylamino)-6-amino-1,3,5-triazine
and 40 mol % of 2,4,6-tris (5-hydroxy-3-oxapentylamino)-1,3,5-triazine.

Suitable phenols (B) are phenols containing one or two hydroxyl groups, such as unsubstituted phenols, phenols substituted by radicals selected from the group consisting of C₁-C₉-alkyl and hydroxyl, and also C₁-C₄-alkanes substituted by two or three phenol groups, di (hydroxyphenyl) sulfones or mixtures thereof.

Preferred phenols include phenol, 4-methylphenol, 4-tert-butylphenol, 4-n-octylphenol, 4-n-nonylphenol, pyrocatechol, resorcinol, hydroquinone, 2,2-bis (4-hydroxphenyl) propane, Bis (4-hydroxyphenyl) sulfone, particularly preferably phenol, resorcinol and 2,2-bis (4-hydroxyphenyl) propane.

Formaldehyde is generally used in the form of an aqueous solution having a concentration of, for example, from 40 to 50% by weight or in the form of compounds which supply formaldehyde in the course of the reaction with (A) and (B), for example in the form of oligomeric or polymeric formaldehyde in solid form, such as paraformaldehyde, 1,3,5-trioxane or 1,3,5,7-tetroxane.

The particularly preferred melamine resin fibers are produced by polycondensing customarily melamine, optionally substituted melamine and optionally phenol together with formaldehyde or formaldehyde supplying compounds. All the components can be present from the start or they can be reacted a little at a time and gradually while the resulting precondensates are subsequently admixed with further melamine, substituted melamine or phenol.

The polycondensation is generally carried out in a conventional manner (See U.S. Pat. No. 4,996,289).

The reaction temperatures used will generally be within the range from 20 to 150° C., preferably 40 to 140° C.

The reaction pressure is generally uncritical. The reaction is generally carried out within the range from 100 to 500 kPa, preferably at atmospheric pressure.

The reaction can be carried out with or without a solvent. If aqueous formaldehyde solution is used, typically no solvent is added. If formaldehyde bound in solid form is used, water is customarily used as solvent, the amount used being generally within the range from 5 to 40, preferably from 15 to 20, percent by weight, based on the total amount of monomer used.

Furthermore, the polycondensation is generally carried out within a pH range above 7. Preference is given to the pH range from 7.5 to 10.0, particularly preferably from 8 to 9.

In addition, the reaction mixture may include small amounts of customary additives such as alkali metal sulfites, for example sodium metabisulfite and sodium sulfite, alkali metal formates, for example sodium formate, alkali metal citrates, for example sodium citrate, phosphates, polyphosphates, urea, dicyandiamide or cyanamide. They can be added as pure individual compounds or as mixtures with each other, either without a solvent or as aqueous solutions, before, during, or after the condensation reaction.

Other modifiers are amines and amino alcohol such as diethylamine, ethanolamine, diethanolamine or 2-diethylaminoethanol.

Examples of suitable fillers include fibrous or pulverulent inorganic reinforcing agents or fillers such as glass fibers, metal powders, metal salts or silicates, for example kaolin, talc, baryte, quartz or chalk, also pigments and dyes. Emulsifiers used are generally the customary nonionic, anionic, or cationic organic compounds with long-chain alkyl radicals.

The polycondensation can be carried out batchwise or continuously, for example in an extruder (See U.S. Pat. No. 4,996,289), in a conventional manner.

Fibers are produced by generally spinning the melamine resin of the present invention in a conventional manner, for example following addition of a hardener, customarily acids such as formic acid, sulfuric acid, or ammonium chloride, at room temperature in a rotospinning apparatus and subsequently completing the curing of the crude fibers in a heated atmosphere, of spinning in a heated atmosphere while at the same time evaporating the water used as solvent and curing the condensate. Such a process is described in detail in U.S. Pat. No. 4,088,620.

If desired, the melamine resin fibers may have added to them up to 25% preferably up to 10%, by weight of customary fillers, especially those based on silicates, such as mica, dyes, pigments, metal powders and delusterants.

Melamine fibers also have outstanding insulative properties, exhibiting a thermal resistance of 0.10 Watts/meter-degree Kelvin and they also provide an endothermic cooling effect, absorbing 5 watts of energy per gram of fiber, when thermally decomposing between 390-410 deg Celsius.
Other Category 1 fibers include water dispersible versions of: meta-aramids such as poly (m-phenylene isophthalamide), for example, those sold under the tradenames NOMEX by E. I. Du Pont de Nemours and Co., TEIJINCONEX by Teijin Limited and FENYLENE by Russian State Complex; para-aramids such as poly (p-phenylene terephthalamide), for example, that sold under the tradename KEVLAR by E. I. Du Pont de Nemours and Co., poly (diphenylether para-aramid), for example, that sold under the tradename TECHNORA by Teijin-Twaron Limited, and those sold under the tradenames TWARON by Teijin-Twaron Limited and FENYLENE ST (Russian State Complex); polybenzimidazole such as that sold under the tradename PBI by Hoechst Celanese Acetate LLC, polyimides, for example, those sold under the tradenames P-84 by Inspec Fibers and KAPTON by E. I. Du Pont de Nemours and Co.; polyamideimides, for example, that sold under the tradename KERMEL by Rhone-Poulenc; partially oxidized polyacrylonitriles, for example, those sold under the tradenames FORTAFIL OPF by Fortafil Fibers Inc., AVOX by Textron Inc., PYRON by Zoltek Corp., PANOX by SGL Technik, THORNEL by American Fibers and Fabrics and PYROMEX by Toho Rayon Corp.; novoloids, for example, phenol-formaldehyde novolac, for example, that sold under the tradename KYNOL by Gun Ei Chemical Industry Co.; poly (p-phenylene benzobisoxazole) (PBO), for example, that sold under the tradename ZYLON by Toyobo Co.; poly (p-phenylene benzothiazoles) (PBT); polyphenylene sulfide (PPS), for example, those sold under the tradenames RYTON by American Fibers and Fabrics, TORAY PPS by Toray Industries Inc., FORTRON by Kureha Chemical Industry Co. and PROCON by Toyobo Co.; flame retardant viscose rayons, for example, those sold under the tradenames LENZING FR by Lenzing A. G. and VISIL by Säteri Fibers Oy Finland, which is a viscose rayon that includes an aluminum silicate modified silica; polyetheretherketones (PEEK), for example, that sold under the tradename ZYEX by Zyex Ltd.; polyketones (PEK), for example, that sold under the tradename ULTRAPEK by BASF; polyetherimides (PEI), for example, that sold under the tradename ULTEM by General Electric Co.; and combinations thereof;

The most preferable Category 1 fibers are those that are either white, off-white, transparent or translucent in color, since any other color in the nonwoven wet-lay flame barrier can negatively effect the look of the composite article, especially when used directly under white or light-colored decorative upholstery and/or mattress ticking fabrics. Thus, when considering that, on an achromatic scale, white paper has a reflectance value of 80% or more and black has about a 10% reflectance value, the preferred white or off white fiber color falls much closer to the 80% reflectance end of the range (e.g., +/−20). In this regard, melamine fibers are particularly well suited for use in the present invention.

An additional inherently flame resistant fiber which is suitable for use in the present invention is a cellulosic fiber such as a viscose rayon based fiber having, for example, a high silica content built into the fiber to provide an insulating barrier in the fiber. A suitable fiber of this nature is a viscose rayon based fiber containing 33% aluminosilicate modified silica (SᵢO₂+Al₂O₃) made by Säteri Oy in Valkeakoski, Finland. The fiber is commonly referred to and has a trade mane of Visil® fiber.

Category 2 fibers: Water dispersible versions of fibers produced (e.g., extruded) from polymers and copolymers made with halogenated monomers, generate oxygen depleting gases which help to prevent volatile decomposition vapors of underlying or adjacent materials such as polyurethane to autoignite, help prolong the life of the category 1 material (mixes or non-mixes) when subjected to open flame and also help existing “surface” flame to self-extinguish. These fiber types include:
Chloropolymeric fibers, such as those containing polyvinyl chloride or polyvinylidene homopolymers and copolymers, for example, those sold under the tradenames THERMOVYL L9S & ZCS, FIBRAVYL L9F, RETRACTYL L9R, ISOVYL MPS by Rhovyl S. A; PIVIACID, Thueringische; VICLON by Kureha Chemical Industry Co., TEVIRON by Teijin Ltd., ENVILON by Toyo Chemical Co. and VICRON, made in Korea; SARAN by Pittsfield Weaving, KREHALON by Kureha Chemical Industry Co. and OMNI-SARAN by Fibrasomni, S. A. de C. V.; and modacrylics which are vinyl chloride or vinylidene chloride copolymer variants of acrylonitrile fibers, for example, those sold under the tradenames PROTEX by Kaneka and SEF by Solutia; and combinations thereof;
Fluoropolymeric fibers such as polytetrafluoroethylene (PTFE), for example, those sold under the tradenames TEFLON TFE by E. I. Du Pont de Nemours and Co., LENZING PTFE by Lenzing A. G., RASTEX by W.R. Gore and Associates, GORE-TEX by W.R. Gore and Associates, PROFILEN by Lenzing A. G. and TOYOFLON PTFE by Toray Industries Inc., poly (ethylene-chlorotrifluoroethylene) (E-CTFE), for example, those sold under the tradenames HALAR by Albany International Corp. and TOYOFLON E-TFE by Toray Industries Inc., polyvinylidene fluoride (PVDF), for example, those sold under the tradenames KYNAR by Albany International Corp. and FLORLON (Russian State Complex), polyperfluoroalkoxy (PFA), for example, those sold under the tradenames TEFLON PFA by E. I. Du Pont de Nemours and Co. and TOYOFLON PFA by Toray Industries Inc., polyfluorinated ethylene-propylene (FEP), for example, that sold under the tradename TEFLON FEP by E. I. Du Pont de Nemours and Co.; and combinations thereof;

Category 3 fibers: Water dispersible versions of inorganic fibers such as:
Fiberglass, carbon, ceramic
Combinations of the above fibers

Category 4 fibers: Water dispersible versions of non-flame retardant fibers such as:
Cotton, wool, silk, mohair, cashmere, kenaf, jute, sisal
   Nylons, polyesters, polyolefins, rayons, lyocells, acrylics, cellulose acetates and polylactides such as those available from Cargill Dow Polymers
   Low-melt bicomponent polyesters, such as Celbond® sold by Kosa company.
   Low melt copolyester fibers that have melting points lower than the melting points or degradation temperatures of the other fibers in the blends. Typical “low-melt” fibers (polyester and polyolefins) used in the industry have melting points of 100 C to 210 C. Standard polyester fiber melts at approximately 260 C.
   Polypropylenes, such as T-151 as sold by Fiber Innovation Technology or by American Fibers and Yarns Co.
   Combinations of the above fibers

Category 5 fibers: Water dispersible pulp fibers made from such as:
Woods, Lyocells, p-aramid, polyesters, nylons, polyolefins, rayons, acrylics, cellulose acetates, polylactides
Combinations of the above fibers

Binder resins include:
acrylic binder preferably modified with a flame retardant (e.g. nitrogen phosphorous, phosphate, aluminum trihydrate, magnesium hydroxide, calcium hydroxide, calcium carbonate, antimony trioxide and mixtures thereof)
styrene acrylonitrile preferably modified with a flame retardant (e.g. nitrogen phosphorous, phosphate, aluminum trihydrate, magnesium hydroxide, calcium hydroxide, calcium carbonate, antimony trioxide and mixtures thereof)
styrene butadiene rubber and preferably modified with a flame retardant (e.g. nitrogen phosphorous, phosphate, aluminum trihydrate, magnesium hydroxide, calcium hydroxide, calcium carbonate, antimony trioxide and mixtures thereof)
ethylene/vinyl chloride copolymer preferably modified with a flame retardant (e.g. nitrogen phosphorous, phosphate, aluminum trihydrate, magnesium hydroxide, calcium hydroxide, calcium carbonate, antimony trioxide and mixtures thereof)
polyvinylacetate preferably modified with a flame retardant (e.g. nitrogen phosphorous, phosphate, aluminum trihydrate, magnesium hydroxide, calcium hydroxide, calcium carbonate, antimony trioxide and mixtures thereof)
Combinations of the above resins

The blend level concentrations (by weight percentages) in the nonwoven wet-lay flame barrier of each of the above Categories are as follows:
Category 1:1-85%, more preferably 5-70% and even more preferably 10-50%.
Category 2: 1-85%, more preferably 5-70% and even more preferably 10-50%.
Category 3: 0-60%, more preferably 0-30% and even more preferably 0-20%.
Category 4: 0-60%, more preferably 0-50% and even more preferably 0-40%.
Category 5: 0-50%, more preferably 0-40% and even more preferably 0-30%.
Resin binder: 5-50%, more preferably 10-40% and even more preferably 15-30%.

In order to meet the objectives of the present invention, the combined weight percentages of the Category 1 and 2 fibers must be at least 20%, and the combined weight percentage of the Category 1, 2, and 3 fibers must be at least 50%, to reach the desired level of flame resistance.

The oxygen depleting gases generated by category 2 fibers are particularly beneficial in combination with category 1 materials alone, or further in combination with Category 4 and/or 5 materials. That is, in addition to helping prevent autoignition of the decomposition products coming from underlying layers, such as polyurethane foam or the like and helping to extinguish any residual flame emanating from overlying material such as dress cover fabric, the oxygen depleting gases from the polymers made with halogenated monomers also coat and protect the carbonaceous char formed during the decomposition of the inherently flame resistant fibers. In this way, there is provided a significantly longer time before the char disintegrates when exposed to air at open flame temperatures. This synergistic blending under the present invention is thus able to withstand extended periods of time with minimal shrinkage of the char barrier; thereby preventing flames from “breaking through” and igniting underlying materials.

Other water dispersible component fibers can also, optionally, be included preferably at relatively low concentrations, such as the natural and synthetic fibers of Category 4, to improve product economics in the end use application. The pulp fibers of Category 5 are also added for product economics, while the inorganic fibers of Category 3 add increased strength.

The above percentage ranges for the various categories is in reference to the percentage by weight of a single layer of material (e.g. a flame barrier whose entire thickness is formed of a common fiber blend or in reference to one layer of a multilayer flame barrier with the other layers either also being provided for flame barrier purposes or not provided for flame barrier purposes). Moreover, the above percentages by weight can also be considered as being applicable to the percentage by weight of the sum of various layers of a multilayer flame barrier. For example, the present invention is intended to include within its scope a multilayer flame barrier combination having the same or differing percentages of materials from categories 1 and/or 2 (including zero percent in one layer of one of the categories 1 and 2 material with the other layer making up the difference) amongst two or more of its layers. For instance, rather than blending various types of fibers in the same layer, the multilayer flame barrier can include one layer designed to provide or emphasize the category 1 material and a second layer designed to provide or emphasize the desired percentage of the category 2 materials. As can be seen from the few examples directly above, the present invention provides a high degree of versatility in forming a wet-lay flame barrier, although, as will become more apparent below, certain combinations of materials, particularly the category 1 and 2 materials, can provide highly advantageous flame barrier functioning. From the standpoint of reducing manufacturing complexity and cost, for example, a single layer or non-multi-layer flame barrier having common blend makeup throughout its thickness (based on, for example, an inputted fiber mix blend “recipe” based on the above noted potential category combinations into a computer processor controlling the wet-lay non-woven product manufacturing process) is preferred for many applications.

The wet-lay flame barrier of this invention also allows for the manufacture of open flame resistant composite articles, while also permitting the continued use of conventional non-flame retardant dress cover fabrics, conventional non-flame retardant fiberfill, and conventional non-flame retardant polyurethane foams, etc.

In accordance with another aspect of the invention, the wet-lay flame barrier herein described allows for the manufacture of open flame resistant end-use composite articles by incorporating the barrier material with additional composite article components such as: conventional non-flame retardant dress cover fabrics, conventional non-flame retardant fiber-fills and conventional non-flame retardant polyurethane foams, which are already used, for example, in making upholstered furniture, mattresses, foundations, pillows, bedspreads, comforters, quilts, mattress pads, automotive seating, public transportation seating, aircraft seating and building insulation layers. The wet-lay flame barrier of the invention can be used without lamination to the dress cover fabric, which may be advantageous over certain forms of currently available flame barriers, since the laminating resins tend to stiffen the “hand” of the upholstered fabric. The wet-lay flame barrier product may also be used as a substitute for conventional stitch-holding spunbond backing material utilized in quilting operations for mattress manufacturing. Another use for this wet-lay barrier is as a flame resistant filler cloth material that can be used as is or it can be coated to become the “non-skid” surface material atop the foundation of a bed set or on the bottom of a single sleep surface mattress. Alternatively, this wet-lay barrier can be placed directly underneath existing “non-skid” filler cloth materials to prevent ignition of the underlying layers in a bed set foundation or the bottom of a single sleep surface mattress. This wet-lay barrier can also, advantageously, be laminated, for example by adhesive coating, to a layer of polyurethane foam, as is current practice in the much of the upholstered furniture industry. This reduces the number of stock units that must be handled in the furniture manufacturing process. Thus, the present invention also provides for continued use of conventional non-flame retardant materials in, for example, upholstered furniture and mattress and foundation formation, without altering or disrupting the conventional composite article manufacturing process, except perhaps making the process more simple by reducing one or more steps in a preexisting process such as removing a step of applying FR material to the article.

### DETAILED DESCRIPTION OF PREFERRED EMBODIMENTS OF THE INVENTION

The present invention is directed at providing a nonwoven wet-lay flame barrier, and particularly one that, when tested in a composite article with a composite test method, such as: TB129 or TB603 for mattresses or bed sets and TB133 for upholstered furniture, the flame barrier allows for the continued use of conventional dress cover fabrics, fiber-fillings and polyurethane foams and the like, while still passing these stringent large open flame tests. It is understood by someone skilled in the art that flame barriers made of the fiber blends or combinations described in this invention, even at overall lower basis weights, can be made to pass less stringent small open flame tests.

The term “wet-lay” is used in a general sense to indicate a relatively high-density nonwoven fiber structure. These materials typically have a greater volume of fiber and binder resin than air. The term is also used to describe nonwoven materials that are produced by dispersing fibers with or without fiber pulp in water, formed into a uniform mat, saturated with a binder resin and then cured in a drying oven and/or over heated calendaring rolls. As used herein, wet-lay also refers to products that are made in a way which is similar to conventional papermaking making processes. Representative examples of basis weights, thickness and other blend and formation characteristics for the wet-lay material of the present invention are provided further below.

The nonwoven wet-lay flame barrier of the present invention is particularly well suited for use as a component material in the manufacture of furniture, bedding and bed clothing. The present invention is thus designed to be incorporated in the manufacturing process of many composite articles without disruption of their current processes and thus the present invention can provide a non-disruptive manufacturing substitute for the non-FR materials currently used by manufacturers or articles such as padding, cushioning, quilting layers, etc.

Composite articles manufactured with the described nonwoven wet-lay flame barrier have the look, feel and surface characteristics of the same non-FR products made without the subject of this invention while providing flame barrier characteristics. For example, one of the standard tests for measuring the open flame resistance of a mattress is California Test Bulletin 603. According to this test, a full-scale mattress and foundation set are exposed to a twin set of flame burners. The top burner is held perpendicular to the top/center/edge and about 1 inch from the surface of the top panel of the mattress; while a side burner is held in a vertical position about 1 inch from the surface midpoint of the length of the bed, at a point where the mattress and foundation meet. Mattresses and foundations of the present invention can employ the above described nonwoven wet-lay flame barrier, by having them, for example, quilted under the mattress ticking fabric and below a layer of standard polyester highloft batting or standard non-FR polyurethane foam. In this case, the wet-lay flame barrier substitutes for a spunbond polyester stitch-holding layer that is normally employed in non-FR type mattresses and foundations. Alternatively, the wet-lay flame barrier of the present invention can be utilized in between a layer of polyester highloft or polyurethane foam and the standard spunbond stitchholding layer, if additional seam strength is required in a quilting operation. Additional stringent open flame tests for which composite articles of the present invention, or composite mock-ups representing these articles, are intended to pass when this barrier is incorporated include: California Test Bulletin 133, the proposed Consumer Product Safety Commission (CPSC) Flammability Test for beds sets and upholstered furniture, the composite British Standard 5852-Crib 5 test, the British Standard 7176 test and the British Standard 7177 test. It is understood by someone skilled in the art that flame barriers made of the fiber blends described in this invention, even at overall lower basis weights, can be made to pass less stringent open flame tests such California's Revised Test Bulletin 117 (TB117—draft 02/02 version) and California's Test Bulletin 604 (TB604—draft test method available through California Bureau of Home Furnishings and Thermal Insulation by contacting contactbhfti@dca.ca.gov) or other small open flame tests.

Formation of the present invention preferably involves standard web formation techniques normally employed for wet-lay type products.

The wet-lay non-woven barrier material of the present invention can be manufactured in a variety of ways some of which are described in Turbak “Nonwovens: Theory, Process, Performance, and Testing” Tappi Press (1993) 1st Ed. pgs 139-151, which section is incorporated herein by reference.

Another process for manufacturing a wet-laid product is described in U.S. Pat. No. 6,497,787, which is incorporated herein by reference. As described in U.S. Pat. No. 6,497,787, a wet lay process comprises mixing fiber components with water to make aqueous fiber slurry under agitation in a mixing tank. The fibers may be used as filaments or as strands of gathered filaments in chopped form. Optionally, continuous filaments can be used as length-oriented reinforcement for the mat. Additional elements to make up the aqueous slurry may be added as is known in the art. For example, antistatic agents, coupling agents, pigments, surfactants, anti foams, colorings, fillers, and pre-binders, such as polyvinyl alcohol.

The aqueous fiber slurry is transferred onto a suitable formation apparatus, such as a moving screen or forming wire on an inclined wire forming machine, wire cylinders, Foudrinier machines, Stevens Former, Roto Former, Inver Former, or Venti Former machines. Preferably, the formation of the mat is on an inclined wire-forming machine. On the formation apparatus, the fibers and the additional slurry elements in the aqueous fiber slurry enmesh themselves into a freshly prepared wet laid fibrous mat, while excess water is separated therefrom. The dewatering step may be conducted by any known method such as by draining, vacuum, etc. The water content of the mat after dewatering and vacuum is preferably in the range of about 60 to about 85%.

After the wet laid fibrous mat is formed, it is transferred to a transport belt, which carries the mat into a means for substantially removing the water. The removal of the water may be conducted by known web drying methods, including the use of a rotary/thru air dryer or oven, a heated drum dryer, an infrared heating source, hot air blowers, microwave emitting source, and the like. At least one method of drying is necessary for removing the water, but a plurality of these methods may be used in combination to remove the water and dry the wet laid fibrous mat. The temperature of the dryer may range from about 120° C. at the start until about 210° C. at the end of the 1st drying process. The airspeed may be in the range of about 0.5 to 1 m/sec.

Optionally a wet end pre-binder may be applied to the mat prior to being transferred to the water removing means. If a pre-binder is used, it is bound to the fibers in the first dryer to form a pre-bonded mat. After passing through the first dryer, the mat is made up of a fiber composition as described elsewhere herein.

One or more binder resins suitable for applications in reinforcing fibers may be used. Suitable binder compositions include a binder such as an acrylic binder, a styrene acrylonitrile binder, a styrene butadiene rubber binder, an ethylene/vinyl chloride copolymer or mixtures thereof. Preferably, the binder resin is an acrylic based binder, or may be a blend of standard thermosetting acrylic binder formed of polyacrylic acid and at least one polyol (e.g., triethanolamine or glycerine) with an acrylic based binder. Examples of suitable acrylic binders for use in the present invention include GL 618 (Rohm & Haas), Rhoplex HA-12 (Rohm & Haas), Rhoplex B-959 (Rohm & Haas), Rhoplex B-15J (Rohm & Haas), Rhoplex NW-1402 (Rohm & Haas), Reynco 124-45A (Reynolds Company), Reynco 124-45B (Reynolds Company), Reynco 124-16C, Reynco 126-70C and mixtures thereof. The binder may be supplied to the fibers at a rate such that the final product contains approximately 5-50% by weight binder.

The binder resin preferably has a low glass transition temperature (Tg) to provide a soft fabric finish. The glass transition temperature of the polymeric binder has an effect on the rigidity and flexibility of the treated veil. Glass transition temperatures of the binder, as calculated by the Fox equation, may be 75° C. or lower. In a preferred embodiment, the glass transition temperature of the binder ranges from about −10° C. to about 10° C. In an alternative preferred embodiment, the glass transition temperature of the binder ranges from about 0° C. to about 50° C.

The binder composition preferably also includes a flame retardant, however, it is believed that the flame retardant may not be required for some products. Non-limiting examples of suitable flame retardants that may be used in the binder composition include nitrogen phosphorous flame retardant, a phosphate flame retardant, aluminum trihydrate, magnesium hydroxide, calcium hydroxide, calcium carbonate, antimony trioxide, and mixtures thereof. The flame retardant may be present in the binder composition in an amount of up to 10-50% by weight of the binder polymer ingredients.

The binder composition may optionally contain conventional additives such as dyes, oils, fillers, thermal stabilizers, emulsifiers, anti-foaming agents, anti-oxidants, organosilanes, colorants, UV stabilizers, and/or other conventional additives. Other additives may be added to the binder composition for the improvement of process and product performance. Such additives include coupling agents (e.g., silane, aminosilane, and the like), dust suppression agents, lubricants, wetting agents, surfactants, antistatic agents, and/or water repellent agents. The binder may be used in any form, such as a powder, a fiber, or a liquid. It is further noted that the above-mentioned binders may also be suitable as a pre-binder.

The wet-lay mat, in one embodiment of the invention, incorporating flame resistant binder resin, is carried through a forced air, gas-fired continuous oven with temperatures up to 500° F. so that curing of the mat takes place. Curing temperatures are dependent on the binder components in the blends. The material is then subjected to final processing such as having the material taken up on rolls and slit to width per application. The material can also be cut into panel size pieces depending on the specific application.

The above described preferred “equipment assemblage” is capable of producing wet-lay nonwoven fiber blends with basis weights of 17 g/m² (with thickness range of 0.025 to 0.25 mm) through 280 g/m² and higher (with a thickness range of 0.4 mm to 4 mm and higher.)

The wet-lay nonwoven material of the present invention preferably has a basis weight of 30 to 300 g/m², more preferably 45 to 150 g/m² and even more preferably, for many intended uses, 60 to 100 g/m². The wet-lay nonwoven material of the present invention also preferably has a thickness falling within a range of 0.01 to 2 mm with a thickness range of 0.03 to 0.75 mm being well suited for many uses of the present invention. As having too low a basis weight for a given thickness at the higher end of the above basis weight ranges could degrade the barrier effect in some instances, it is desirable for some applications to use the lower end basis weight values in conjunction with lower end thickness ranges while the higher end basis weight are generally not subject to the same concerns.

The preferred denier values of the fibers used in the nonwoven wet-lay fiber blend of the present invention preferably are in the range of 0.8 to 200 dtex, with ranges of 0.9 to 50 dtex and 1 to 28 dtex being well suited for many applications of the present invention.

The preferred staple lengths of the fibers used in the nonwoven wet-lay fiber blend of the present invention preferably are in the range of 3 to 51 mm, with ranges of 6 to 38 and 12 to 32 being well suited form many applications of the present invention.

The following non-limiting test example I is set forth to demonstrate the effectiveness of a wet-lay flame barrier of the invention.

### Wet-Lay FR Barrier

### EXAMPLE I

A wet-lay flame barrier made with following materials and tested with a large burner flame source, is set forth according to the procedure as follows:

A blend of 80% water dispersible melamine fiber (Basofil HF100, from Basofil Fibers LLC), having a cut length of 6 mm-19 mm, and 20% water dispersible wood pulp is combined in a three to four ratio with a 12.5 mm water dispersible chloropolymeric fiber (Isovyl L9S, from Rhovyl S. A.) in a conventional paper making hydrapulper process.

The melamine fiber/wood pulp/chloropolymeric fiber water mixture is sent to a conventional paper making belt press to increase solids content up to a 25% wetcake.

The melamine fiber/wood pulp/chloropolymeric fiber wetcake is blended, in a fibrous water slurry with a 12.5 mm water dispersible 11 micron fiberglass (from Owens Corning) so that the dry fiber ratio of melamine fiber/wood pulp/chloropolymeric fiber/fiberglass is 30%/7.5%/50%/12.5%, respectively.

The above fiber blend slurry is processed on a wet lay machine to form a uniform fibrous mat. A flame resistant binder resin consisting of an aqueous blend of a modified acrylic polymer and an ethylene/vinyl chloride polymer are combined to yield a resin with a glass transition temperature of approximately −5 to 0 C. This flame resistant binder resin blend is modified with antimony trioxide, which is added at ⅓ of the total resin content when calculated on active ingredients. The fibrous matt is saturated to provide a dry solids level of 20% flame resistant binder resin.

The binder saturated mat is then sent through curing ovens set at 400 degF. to dry the mat and cure the binder resin. The flame barrier product is then taken up on rolls at the end of the wet-lay process. The final composition of the wet-lay flame barrier is melamine fiber/wood pulp/chloropolymeric fiber/fiberglass/binder resin at 24%/6%/40%/10%/20%, respectively.

The above produced wet-lay flame barrier, having a basis weight of 98 g/m² (2 lbs per 100 square feet), is tested as follows:

A test rig was constructed where 36″×24″ wet-lay flame barrier samples are wrapped and clamped around a spring-loaded rectangular metal fixture made from solid aluminum tubing and standard piping connections and tube fittings in each of the eight corners. A description of the test rig is as follows:
1) The above described metal fixture is made in two pieces with overall dimensions of 29″×8.5″×9″ (l×w×h) and designed with metal springs being placed in the bottom corner pipe connectors of the fixture.
2) The top section of the fixture is placed in the bottom section and compressed and held under tension with short bungee cords while a 36″×24″ (l×w) sample of the wet-lay flame barrier is wrapped completely around the fixture.
3) Two small metal binder clips are used to attach the back end of the sample to the top/back aluminum rod of the rectangular fixture and then the sample is wrapped completely around leaving a 2″ overlap to be secured to the top/back aluminum rod with four additional metal binder clips.
4) Once the sample is secure, the bungee cords are removed, causing a fixed amount of tension to be applied to the sample, similar to that observed on materials in an actual innerspring mattress.
5) The wrapped fixture is placed on two O-ring stands which lift it ˜11″ above the bottom of a fume hood. These O-ring stands are placed at either end of the fixture to lift it above the bottom of the fume hood.
6) A 208 mm “T-burner”, designed according to specifications detailed in ASTM E-1590, is positioned 1″ away and parallel to the bottom center rod of the wrapped fixture, simulating the same location as is used in the full scale mattress burn test as specified in California Test Bulletin 129 (also known as ASTM E-1590).
7) The T-Burner is supplied with 12 liters per minute of propane gas, which is delivered through a flowmeter from a “gas grill” propane tank and ignited with a Bunsen burner.
8) A stopwatch is used to measure the time until the flame generated from the T-burner ignition source “burns through” the sample barrier material.
9) Other information which can be obtained from this indicative test include:
   A qualitative assessment of the shrinkage observed in the barrier due to flame
   The ability of the barrier to self-extinguish once the ignition source is removed

The wet-lay flame barrier, weighing 98 g/m² (2 lbs per 100 square feet) was produced as described above and provided a average burn through time of 3 minutes and 28 seconds, with the test fixture and procedure as described above. The flame barrier demonstrated virtually no shrinkage during the burn test and completely self-extinguished when the flame source was removed. The above test is indicative of large open flame tests such as TB129, which incorporates a 3 minute ignition burn time, and TB603, which incorporates a 50 second side burner ignition time and a 70 second top burner ignition time.

### TB603 Bed Burn Test Wet-Lay FR Barrier as a Filler Cloth FR Barrier on the Bottom of a Single Sleep Surface Mattress

The wet-lay flame barrier, weighing 61 g/m² (1.25 lbs per 100 square feet) was produced with the same process as described above in Example I.

A residential twin bed set was constructed with the 61 g/m² wet-lay FR barrier as follows:

Mattress Top Panel
Standard ticking fabric
1 layer of 0 a FR highloft barrier
1 layer of ¾″ polyurethane foam
1 layer of 1.25 osy polyester spunbond backing
Quilted with standard polyester thread
Flanged with standard 2.25 osy polypropylene spunbond and stapled to innersprings

Mattress Bottom Panel
1 layer shoddy pad over innersprings
2 layers ⅜″ polyurethane foam
1 layer of the 61 g/m² wet-lay flame barrier made with the same process as described in Example I above, cut to 45″×80
Standard non-FR filler cloth sewn to mattress border with standard polyester thread

Mattress Border—Attached to Top Panel with 50 Tex Kevlar Thread
Standard ticking fabric
1 layer of a FR highloft
1 layer of 0.5 osy polyester spunbond backing
Quilted with standard polyester thread
Serged with standard polyester thread

Foundation Top
1 layer shoddy pad over innersprings
1 layer of the 61 g/m² wet-lay flame barrier made with the same process as described in Example I, cut to 45″×80″
Standard non-FR filler cloth sewn to foundation border with standard polyester thread

Foundation Bottom
1 layer 2.5 osy Elite polypropylene dust cover

Foundation Border—Standard Border Attached to a Standard Non-FR Filler Cloth with Standard Polyester Thread
Standard ticking fabric
1 layer a FR highloft
1 layer of 0.5 osy polyester spunbond backing
Quilted with standard polyester thread
Serged with standard polyester thread

The above constructed residential twin bed set was tested at Underwriters Laboratories (Northbrook, Ill.) according to California Test Bulletin 603. The Peak Rate of Heat Release was 34 KW (maximum allowable rate of heat release is 200 KW) and the Total Heat Release was 2.2 MJ (maximum allowable in first 10 minutes is 25 MJ). This test was considered a significant pass of CAL TB 603.

The flame barrier described above is but one exemplary material within the scope of the present invention. Many other combinations of Category 1, 2, 3, 4, and 5 fibers are possible using other of the binder resins. Thus, the invention is to be limited only by the language of the following claims.

What is claimed is:

1. A flame barrier for use in mattress, foundations, upholstered furniture, fiber-filled bed clothing, transportation seating, office panels, building insulation applications and the like, comprising:
(a) a relatively thin, relatively high density, wet lay, non-woven fabric including a combination of inherently flame retardant water dispersible fibers, water dispersible polymeric fibers derived from polymers made with halogenated monomers, and a binder resin;
(b) wherein the fabric has a maximum thickness of about 2 mm and a minimum density of about 50 kg/m³.

2. The flame barrier of claim 1 wherein the percentage by weight of the water dispersible inherently flame retardant fibers is about 1 to 85% and the percentage by weight of the with water dispersible polymer fibers derived from polymers made with halogenated monomers is about 1 to 85% by weight and the percentage by weight of the binder resin is about 5% to 50%, and wherein the combined percentage by weight of the inherently flame retardant fibers and the fibers derived from polymers made with halogenated monomers is at least about 20% by weight.

3. The flame barrier of claim 2 wherein said water dispersible inherently flame-retardant fibers are selected from the group consisting of melamines, meta-aramids, para-aramids, polybenzimidazole, polyimides, polyamideimides, partially oxidized polyacrylonitriles, novoloids, poly (p-phenylene benzobisoxazoles), poly (p-phenylene benzothiazoles), polyphenylene sulfides, flame retardant viscose rayons, polyetheretherketones, polyketones, polyetherimides, and combinations thereof.

4. The flame barrier of claim 2 wherein the water dispersible fibers derived from polymers made with halogenated monomers are selected from the group consisting of polyvinyl chloride homopolymers and copolymers, polyvinylidene homopolymers and copolymers, modacrylics, polytetrafluoroethylene, polyethylene-chlorotrifluoroethylene, polyvinylidene fluoride, polyperfluoroalkoxy, polyfluorinated ethylene-propylene; and combinations thereof.

5. The flame barrier of claim 2 wherein said binder resin is selected from the group consisting of acrylic, styrene acrylonitrile, styrene butadiene rubbers, ethylene/vinyl copolymer, polyvinylacetate, and combinations thereof, all of which have been modified with a flame retardant material.

6. The flame barrier of claim 5 wherein the binder resin is modified with a flame retardant material.

7. The flame barrier as recited in claim 2 further comprising up to 60% by weight water dispersible inorganic fibers selected from the group consisting of fiberglass, carbon, and ceramic fibers and combinations thereof, and the combined percentage by weight of the inherently flame retardant fibers and the fibers derived from polymers made with halogenated monomers and the inorganic fibers is at least about 50% by weight.

8. The flame barrier as recited in claim 2 and further including up to 60% by weight water dispersible non-flame retardant fibers selected from the group consisting of nylons, polyesters, polyolefins, rayons, acrylics, cellulose acetates, lyocells, polylactides, cottons, wools, mohairs, silks, cashmeres, kenaf, jute, sisal and combination thereof.

9. The flame barriers of claim 2 and further including up to 50% by weight water dispersible pulp fibers selected from the group consisting of nylons, polyesters, polyolefins, rayons, acrylics, cellulose acetates, lyocells, polylactides, woods, p-aramids and combinations thereof.

10. The flame barrier of claim 2 wherein said flame barrier is comprised of a plurality of flame barrier layers.

11. The flame barrier of claim 10 wherein a first of said layers includes said water dispersible inherently flame retardant fibers and water dispersible polymer fibers derived from polymers made with halogenated monomers and a flame resistant binder resin and a second of said layers includes water dispersible inherently flame retardant fibers and a flame resistant binder resin and is free of water dispersible polymer fibers derived from polymers made with halogenated monomers.

12. A product upholstered or manufactured with the nonwoven wet-lay flame barriers of claim 2.

13. The product of claim 12 wherein said product is a composite article comprising the flame barrier and at least one other article component.

14. The product of claim 13 wherein said at least one other article component includes a foam layer.

15. The product of claim 12 wherein said product is a mattress or foundation component.

16. The product of claim 13 wherein said at least one other article component is in contact with said flame barrier and is less flame resistant or flame retardant than said flame barrier.

17. The flame barrier as recited in claim 2 wherein said non-woven wet-lay flame barrier has a basis weight of 40 g/m² to 200 g/m².

18. A flame barrier comprising a non-woven, wet lay fabric which includes the following fiber blend:
(a) 1 to 85% by weight of water dispersible inherently flame retardant organic fibers;
(b) 1 to 85% of water dispersible polymeric fibers derived from polymers made with halogenated monomers;
(c) 0 to 60% of water dispersible inorganic fibers;
(d) 0 to 60% of water dispersible non-flame resistant fibers;
(e) 0 to 50% of water dispersible pulps;
(f) 5 to 50% of flame resistance binder resin; and
(g) wherein the combined weight percentages of the fibers in (a) plus (b) must equal at least 20% and the weight of the fibers in (a)+(b)+(c) must equal at least 50%.

19. The flame barrier of claim 18 wherein:
(a) said water dispersible inherently flame-retardant organic fibers are selected from the group consisting of melamines, meta-aramids, para-aramids, polybenzimidazole, polyimides, polyamideimides, partially oxidized polyacrylonitriles, novoloids, poly (p-phenylene benzobisoxazoles), poly (p-phenylene benzothiazoles), polyphenylene sulfides, flame retardant viscose rayons, polyetheretherketones, polyketones, polyetherimides, and combinations thereof;
(b) the water dispersible fibers derived from polymers made with halogenated monomers are selected from the group consisting of polyvinyl chloride homopolymers and copolymers, polyvinylidene homopolymers and copolymers, modacrylics, polytetrafluoroethylene, polyethylene-chlorotrifluoroethylene, polyvinylidene fluoride, polyperfluoroalkoxy, polyfluorinated ethylene-propylene; and combinations thereof; and
(c) wherein said flame resistant binder resins are selected from the group consisting of acrylic, styrene acrylonitrile, styrene butadiene rubbers, ethylene/vinyl copolymer, polyvinylacetate, and combinations thereof, all of which have been modified with a flame retardant material.

20. The flame barrier of claim 18 wherein said water dispersible inherently flame retardant fibers represent 5 to 70% by weight of said flame barrier and wherein the water dispersible fibers derived from polymers made with halogenated monomers and represent 5 to 70% by weight of said flame barrier and wherein the flame resistant binder resin represent 10 to 40% by weight of said barrier.

21. The flame barrier of claim 18 wherein said inherently flame retardant organic fibers provide 10 to 50% by weight of said fiber blend, and wherein fibers derived from polymers made with halogenated monomers provide 10 to 50% by weight of said fiber blend, and wherein the flame resistant binder resin represent 15 to 30% by weight of the said barrier.
